(19) United States
(12) Patent Application Publication
(10) Pub. No.: US 2013/0293010 A1
(43) Pub. Date: Nov. 7, 2013

(54) CURRENT SUPPLY ARRANGEMENT WITH A FIRST AND A SECOND CURRENT SUPPLY DEVICE, WHEREIN THE SECOND CURRENT SUPPLY DEVICE IS CONNECTED TO THE FIRST CURRENT SUPPLY DEVICE

(71) Applicants: Peter Wallmeier, Lippstadt (DE); Wolfgang Paul, Warstein-Belecke (DE)

(72) Inventors: Peter Wallmeier, Lippstadt (DE); Wolfgang Paul, Warstein-Belecke (DE)

(73) Assignee: AEG POWER SOLUTIONS B.V., Zwanenburg (NL)

(21) Appl. No.: 13/598,904

(22) Filed: Aug. 30, 2012

(30) Foreign Application Priority Data
May 4, 2012 (EP) 12 166 869.3

(51) Int. Cl. H02J 3/00

(52) U.S. Cl. 307/18

(57) ABSTRACT

A current supply arrangement with p first current supply devices and a second current supply device, n first transformers having a secondary winding with several taps. The secondary windings of each first transformer in each first current supply device are connected with one another via a power controller at a first node. The first node together with a tap for a reference potential of the at least one secondary winding of the first transformer, to which the first current supply device is connected, forms a first output, to which a series connection of loads, in particular polysilicon rods in a reactor for producing polysilicon according to the Siemens process, are connected, wherein the second current supply device has at an input with n terminals and q converter groups for converting n-phase AC current into m-phase AC current and the input is connected with the q converter groups.

### BACKGROUND OF THE INVENTION

(1) Field of the Invention

The present invention relates to a current supply arrangement with p first and at least one second current supply device,
wherein the current supply arrangement comprises n first transformers,
wherein each transformer includes at least one secondary winding with several taps,
wherein at least two first taps of the secondary winding of each transformer in each first current supply device are connected with one another via a power controller at a first node,
wherein the first node of each current supply device together with a tap for a reference potential of the secondary winding of the transformer, to which the first current supply device is connected, forms a first output, to which a series connection of loads, in particular polysilicon rods in a reactor for producing polysilicon according to the Siemens process, can be connected,
wherein the at least one second current supply device has an input with n terminals and q converter groups for converting n-phase AC current into m-phase AC current and the input of the second current supply device is connected with the at least one converter group,
wherein the at least one second current supply device has an output with q*m+1 terminals which are connected inside the at least one second current supply device with terminals of the converter group,
wherein the circuit arrangement comprises p first switching groups,
which each have an output with at least q*m+1 terminals, to which the loads or a portion of the loads can be connected, which can be connected in series to the first current supply device,
which each have a group of at least q*m+1 controllable switching means, wherein the switching means of one group in a dosed state connect the terminals of the output of the at least one second current supply device with the terminals of the output, and
which have a control input which is connected to the control terminals of the switching means,
wherein n, m, p and q are natural numbers,

The term multi-phase AC current system, also to be understood within the context of the present invention as a two-phase AC current system, refers to any AC current system having several AC currents with the same frequency, which results in mutually constant, identical phase angles yielding a sum of 360°.

(2) Description of Related Art

A current supply arrangement of this type is disclosed in the document EP 2 388 236 A1, wherein in the current supply arrangement disclosed in this document n=3, m=2, p=6 and q=2.

With such current supply arrangement for supplying power to a reactor for producing polysilicon according to Siemens process, electric energy can advantageously be supplied to the silicon rods, which are arranged inside the reactor and electrically connected to the current supply arrangement, both from the first current supply devices as well as from the second current supply device.

Because the first current supply devices for supplying power to the silicon rods are designed for high currents at low voltages and the second current supply device for supplying the silicon rods is designed for low currents at high voltages, the suitable current supply devices for supplying power to the silicon rods can be selected commensurate with the state of the silicon rods.

In a first phase at the beginning of a deposition process, when the silicon rods are present in form of so-called thin rods and have a very high ohmic resistance, the silicon rods are advantageously connected to the second current supply device, until the current flowing through the silicon rods produced by the high voltage has heated the silicon rods to a point where the ohmic resistance suddenly drops, which is also referred to as ignition of the silicon rods. When this state is reached, the silicon rods have a smaller resistance so that in the second phase following the first phase, the first current supply devices with high currents at low voltages can be used for supplying power to the silicon rods. The voltage can advantageously be adjusted by voltage sequence control such that the power converted in the silicon rods during the deposition process remains approximately constant.

Because the second power supply device is used only during the first phase until ignition, and the second phase is significantly longer than the first phase, a second current supply device to which sequentially the different loads or groups of loads can be connected is advantageously employed, as described in EP 2 388 236 A1. The silicon rods are thus not ignited simultaneously, but rather sequentially.

The loads are hereby connected to the second current supply device by way of the aforementioned switching means assembly, which makes it possible to connect the output of the second current supply device sequentially with the outputs of the switching means assembly, to which the loads, i.e. the silicon rods, are connected.

In this way, a second current supply device could be used for several groups of loads, wherein each group is connected to a first current supply device. A second current supply device is therefore not required for each group of loads.

In this way, in particular also the complexity of several medium voltage transformers could be reduced to a single medium voltage transformer which provides a sufficiently high voltage for the second current supply device.

### BRIEF SUMMARY OF THE INVENTION

It is the object of the invention to further reduce the complexity for the second current supply device.

This object is attained according to the invention in that each terminal of the input of the at least one second current supply device is connected to a first tap of a secondary winding of one of the transformers, and that the taps for a reference potential of the secondary windings of the transformers, to which the terminals of the input of the at least one second current supply device are connected, can be connected with one another by way of controllable switching means.

According to the improvement attained with the invention, the components installed for the first current supply device can now also be used for the second current supply device. In this way, components previously required for the connection of the second current supply device to a power grid can be eliminated or at least reduced in size. For example, in particular the first transformers or portions of the first transformers can also be used for supplying electric energy to the second current supply devices. While previously a medium voltage transformer was required for the second current supply device, this transformer can now be eliminated or replaced by a smaller transformer.

The first transformers may be connected on the primary side in form of a polygon and connected to a multi-phase AC current grid with n phases.

Primary windings of the first transformers, to the secondary windings of which the terminals of the input of the at least one second current supply device are connected, are preferably located in different paths of the polygon. In this way, uniform loading of the supply grid can be achieved.

The first transformers made have one or more than one secondary winding.

The secondary windings of the first transformers, to which the terminals of the input of the at least one second current supply device are connected, may be different secondary windings than the secondary windings connected to the first current supply device. Dedicated secondary windings, which are not used for supplying power to the first current supply devices, would then be provided for supplying power to the second current supply device. The primary windings of the first transformers are then commonly used for supplying power to the first current supply devices and the at least one second current supply device.

Alternatively, first current supply devices may be connected to the secondary windings of the first transformers, to which the terminals of the input of the at least one second current supply device are connected. Both the primary windings and the secondary windings of the first transformers may then be commonly used for supplying power to the first current supply devices and the at least one second power supply device.

First power supply devices may be connected to all secondary windings of the first transformers.

The at least one converter group may include at least one or several second transformers. The converter group may include two second transformers, each having a secondary winding. Single-phase AC voltages with opposite phases may be present at the secondary winding of the two transformers, producing a common two-phase AC voltage at the two secondary windings.

Alternatively, the second transformers may be m-phase transformers, producing an m-phase AC voltage at their secondary windings.

The at least one converter group may include at least one or several converters, in particular frequency converters. The n-phase voltage at the input of the second current supply device may be converted into a single-phase or an m-phase voltage with the converters of a converter group.

The current supply arrangement may include a controller for controlling the power controllers in voltage sequence control.

The current supply arrangement may include a controller for controlling the switching means of the first switching groups.

The current supply arrangement may also include a controller for controlling the switching means of the second switching group.

The controllers for controlling the switching means of the first switching groups and the switching means of the second switching group may be coupled with one another or combined in a controller such that the switching means of the second switching group are closed only when the switching means of the first switching group are controlled to be closed.

### BRIEF DESCRIPTION OF THE SEVERAL VIEWS OF THE DRAWINGS

Additional features of the present invention will be described in an example of a current supply arrangement according to the invention with reference to the appended circuit diagrams. It is shown in:

FIG. 1 a circuit diagram of first transformers and their circuit,

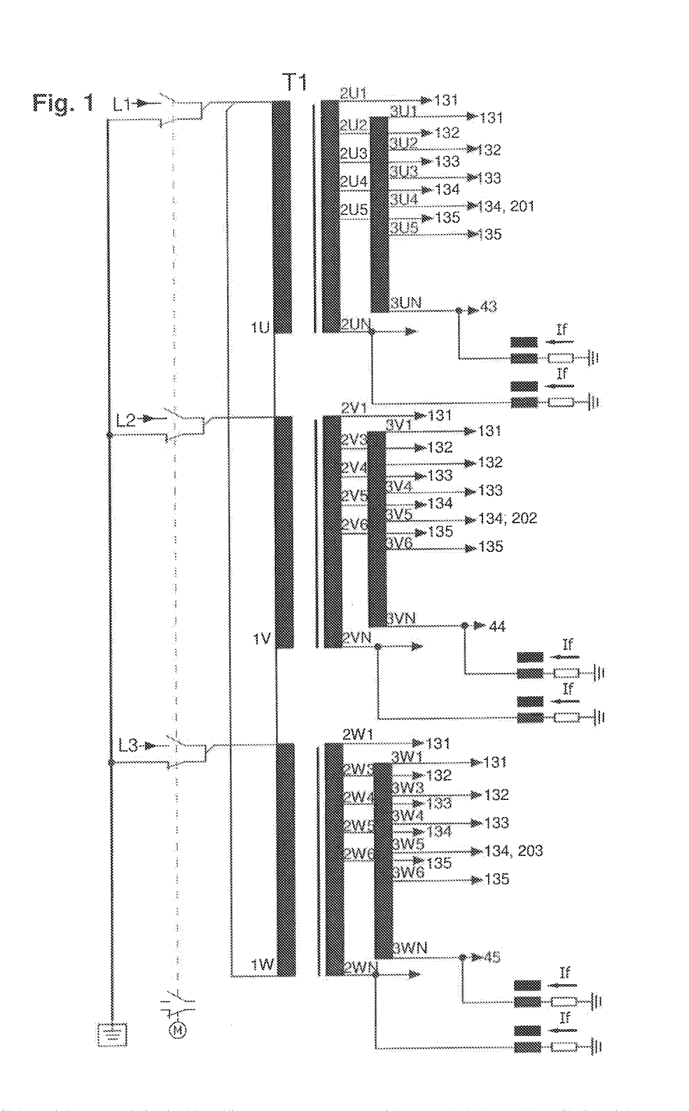

FIG. 2 a circuit diagram of a first power supply device in a first variant, a first switching group in a first variant, and loads connected thereto,

FIG. 3 a circuit diagram of a first current supply device in a second variant, a first switching group in the first variant, and loads connected thereto,

FIG. 4 a circuit diagram of a first power supply device in a third variant, a first switching group in a second variant and loads connected thereto

FIG. 5 a circuit diagram of a second current supply device, and

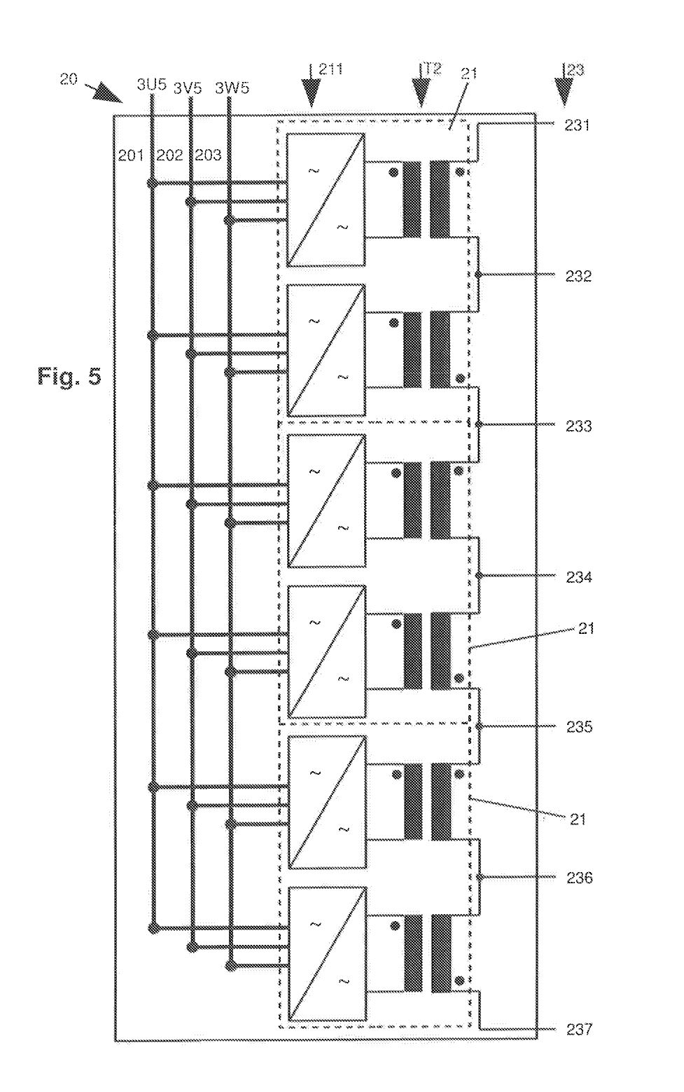

FIG. 6 the circuit diagram of a second switching group.

### DETAILED DESCRIPTION OF THE INVENTION

The current supply arrangement according to the invention and described with reference to the Figures includes n=3 first transformers (T1), p=6 first current supply devices 1, a second current supply device 2, p=6 first switching groups 3 and a second switching group 4.

The primary windings 1U, 1V, 1W of the first transformers T1 are connected in a Delta configuration, wherein the corners of the triangle are connected via load switches to the three-phase conductors L1, L2, L3 of a three-phase power grid. The load switches are normally-open switches. The corners of the triangle are also connected to ground via normally-closed switches. The normally-open switches and the normally-closed switches are operated simultaneously by a common drive.

The first transformers T1 have each two secondary windings 2U, 3U, 2V, 3V, 2W, 3W. Each secondary winding 2U, 3U, 2V, 3V, 2W, 3W has six taps 2U1 to 2U5, 2UN, 3U1 to 3U5, 3UN, 2V1 to 2V5, 2VN, 3V1 to 3V5, 3VN, 2W1 to 2W5, 2WN, 3W1 to 3W5, 3WN. A secondary-side reference potential is present at each tap 2UN, 3UN, 2VN, 3VN, 2WN, 3WN of each secondary winding 2U, 3U, 2V, 3V, 2W, 3W. Voltages for the reference potential with respect to the taps 2UN, 3UN, 2VN, 3VN, 2WN, 3WN can be tapped at the remaining five taps 2U1 to 2U5, 3U1 to 3U5, 2V1 to 2V5, 3V1 to 3V5, 2W1 to 2W5, 3W1 to 3W5, hereinafter also referred to as first taps.

The taps 2UN, 3UN, 2VN, 3VN, 2WN, 3WN for the reference potential are connected via a ground fault detectors with ground potential.

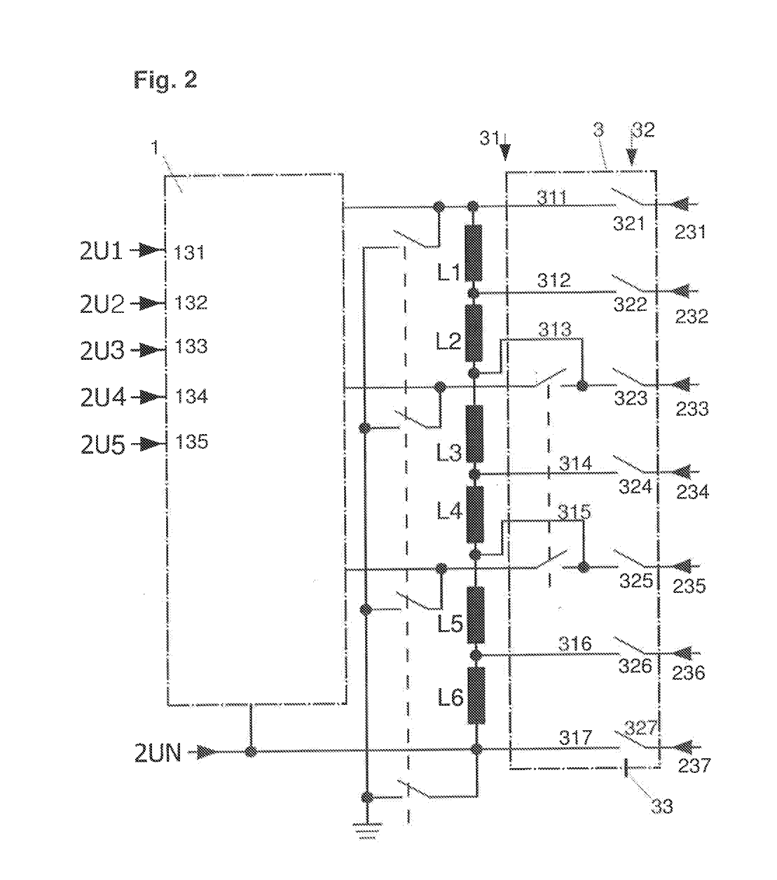

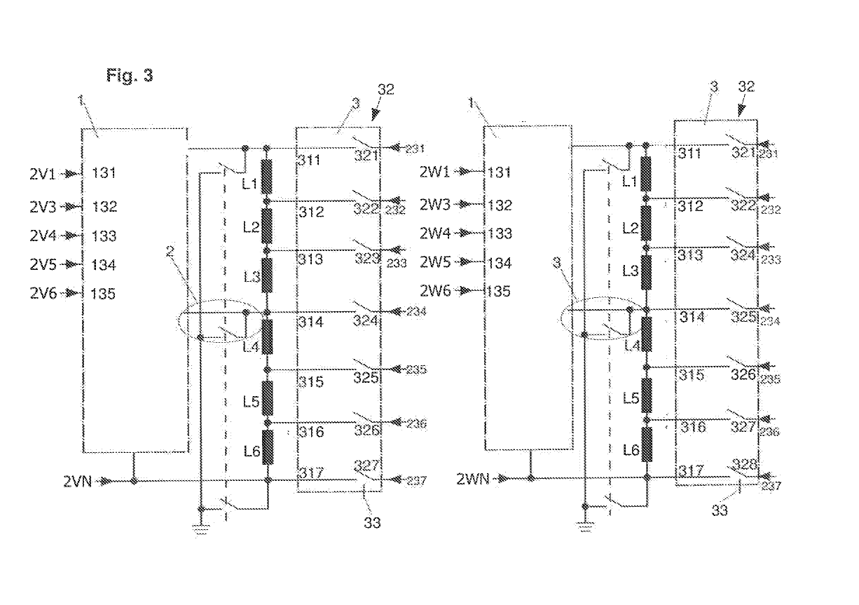

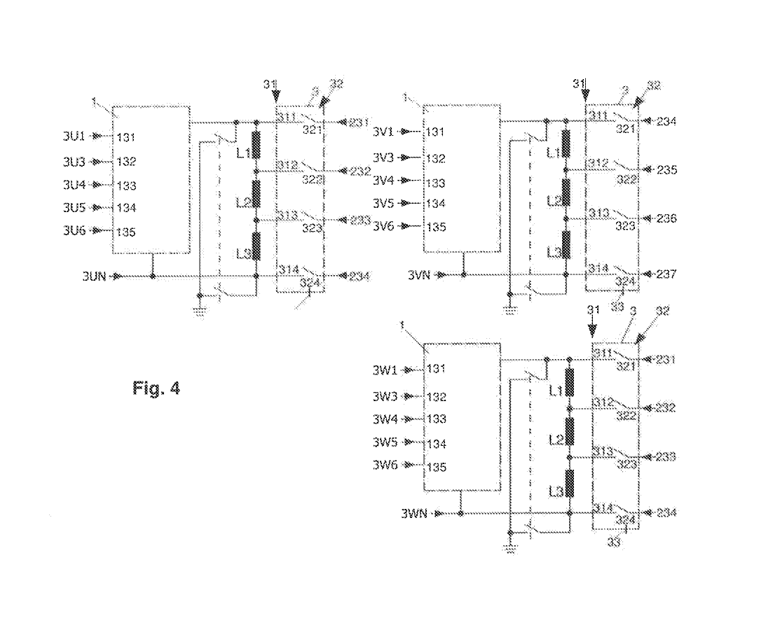

The first current supply devices 1 illustrated in FIGS. 2, 3 and 4 are constructed similarly. They are used, on one hand, for supplying power to the connected loads in a series connection. Accordingly, the first current supply devices have identical construction. The loads can also be arranged in groups using the first current supply devices according to FIGS. 2 and 3 and the groups of loads formed by this grouping can be connected in parallel and supplied with electric energy. The first current supply devices according to FIGS. 2, 3 and 4 are different in the following manner:

Whereas the current supply devices according to FIG. 2 are designed to supply electric energy to three groups of to loads each connected in series as well as in parallel, the current supply devices illustrated in FIG. 3 are designed to supply electric energy to two groups with three loads each corrected in series as well as in parallel. This third variant of the first current supply device according to FIG. 4 is designed to only supply electric energy to three loads connected in series.

Each first current supply device 1 has terminals 131, 132, 133, 134, 135 which are connected with the first taps 2U1 to 2U5, 3U1 to 3U5, 2V1 to 2V5, 3V1 to 3V5, 2W1 to 2W5, 3W1 to 3W5 of a secondary winding 2U, 3U, 2V, 3V, 2W, 3W of a first transformer T1. The terminals 131, 132, 133, 134, 135 are connected inside the first current supply device with a node 12 via power controllers 11. This node 12 together with the tap 2UN, 3UN, 2VN, 3VN, 2WN, 3WN for the reference potential of the secondary winding 2U, 3U, 2V, 3V, 2W, 3W, with which the terminals 131, 132, 133, 134, 135 are connected, forms an output of the first current supply device 1. Serially connected loads are connected to this output of the first current supply device 1.

For switching between a parallel connection and a series connection of the loads, the first current supply devices have in the first variant (FIG. 2) and in the second variant (FIG. 3) a different wiring pattern and different switching means, which are illustrated in FIG. 2 and in FIG. 3, but will not be further described here, because they were already described in detail in previously published documents.

The series connections formed of the loads L1 to L6 (FIG. 2 and FIGS. 3) and L1 to L3 (FIG. 4) are, as already described, connected to the output of one of the first current supply devices. Each individual load L1 to L6 and L1 to L3, respectively, is also connected to a first switching group 3.

The first switching groups 3 have in the first variant (FIG. 2 and FIG. 3) an output 31 with q*m+1, i.e. when m=2 and q=3, seven terminals 311, 312, 313, 314, 315, 316, 317. The loads L1 to L6 are connected to these terminals 311, 312, 313, 314, 315, 316, 317. Each load is connected with two of the terminals 311, 312, 313, 314, 315, 316, 317, supplying current to the load from the second current supply device.

The first switching groups 3 have each a group 31 of at most q*m+1 controllable switching means. In the first variant of the first switching group, the first switching groups have seven controllable switching means 321, 322, 323, 324, 325, 326, 327. The switching means 321, 322, 323, 324, 325, 326, 327 of a group 32 connect in a closed state the terminals 311, 312, 313, 314, 315, 316, 317 of the output 31 with the terminals 24, 25, 26, 27, 28, 29, 2A of the output of the second current supply device 2.

The first switching groups 3 in the second variant (FIG. 4) are different from those in the first variant (FIGS. 2 and 3) in that the output has not seven, but only four terminals 311, 312, 313, 314 and the group of the switching means has only four switching means 321, 322, 323, 324. The three loads L1 to L3, which also connected to the second current supply device 1 in the second variant, are connected to these four terminals 311, 312, 313, 314.

The controllable switching means 321, 322, 323, 324, 325, 326, 327 of both variants of first switching groups have control terminals which are connected to a controller (not illustrated) via a control input 33 of the first switching group 3.

The controller for controlling the first switching groups controls all first switching groups. It ensures that when electric energy should be supplied from the second current supply device, the switching means 321, 322, 323, 324, 325, 326, 327 of preferably a single first switching group 3 are closed.

The second current supply device 2 has an input 20 with n=3 terminals 201, 202, 203, wherein the terminal 201 is connected with the terminal 3U4, the terminal 202 with the terminal 3V4, and the third terminal 203 with a terminal 3W4. The second current supply device 2 has q=3 converter groups 21. These converter groups 21 are connected with the terminals 201, 202, 203, i.e. the converter groups 21 receive a three-phase voltage from the secondary windings 3U, 3V and 3W. The three-phase voltage is converted in the converter groups 21 into an m-phase voltage, with m=2. In other words, a two-phase voltage with a phase of 180° is present at the outputs of the three converter groups 21.

Each converter group 21 has two converters 211 connected in parallel at an input side, wherein the converters 211 are connected at an output side with the terminals 201, 202, 203 of the input 20 of the second current supply device 2. The converters 211 convert the three-phase voltage into a single-phase AC voltage. The converter groups 21 also include two second transformers T2, which transform the single-phase AC voltage at the output of the converter 211 Primary windings of the two second transformers T2 of a converter group 21 have the same winding sense, whereas the secondary windings of the two transformers T2 have opposite winding sense. In this way, voltages with opposite phases are produced at the output of the two second transformers T2.

Secondary-side terminals of the two second transformers T2 are connected with one another at second nodes 22 such that the voltage drop across the secondary windings 2 of second transformers interconnected at the node 22 is zero.

Two second transformers T2 are connected only with a single other second transformer T2. Accordingly, these transformers T2 are connected with only a single second node 22, whereas one of the secondary terminals of each of these transformers T2 is not connected with any node 22.

These terminals of the secondary sides of the second transformers T2 that are not connected with a second node 22 as well as the second nodes are connected with the terminals 231, 232, 234, 235, 236, 237 of the output 23 of the second current supply device 2, to which the first switching groups 3 are connected.

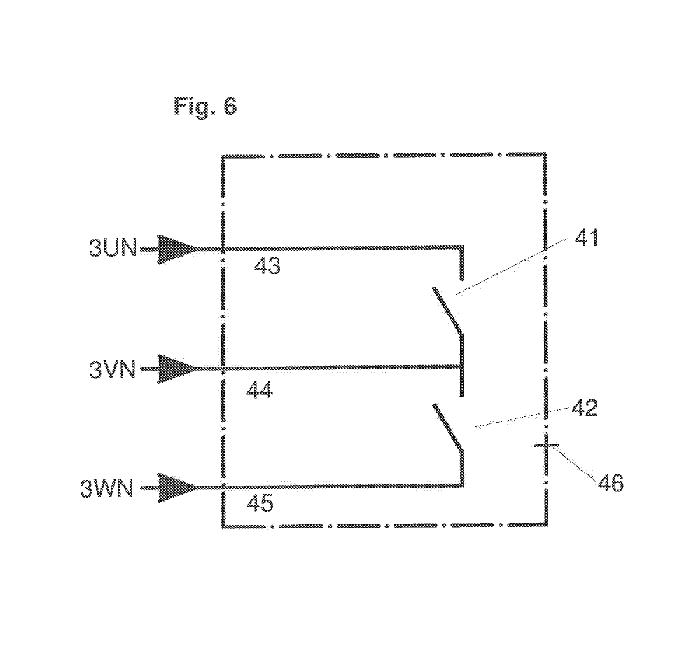

The second switching group 4 (FIG. 6) has three terminals 43, 44, 45 which are connected with the taps 3UN, 3VN, 3WN. The second switching means group 4 furthermore has two controlled switching means 41, 42 configured to connect the terminals 43, 44, 45 with one another. In addition, a control input 46 is provided via which the switching means 41, 42 can be controlled by a controller (not illustrated). When the second current supply device 2 is to be used for supplying electric energy to the loads, the switching means 41, 42 must be controlled so as to be closed. The switching means then form a star point, enabling current to flow from the first transformers T1 to the second current supply device 2.

1. A current supply arrangement comprising
p first current supply devices (1) and at least one second current supply device (2),
wherein the current supply arrangement comprises n first transformers (T1),
wherein each first transformer (T1) comprises at least one secondary winding (2U, 3U, 2V, 3V, 2W, 3W) with several taps (2U1 to 2U5, 2UN, 3U1 to 3U5, 3UN, 2V1 to 2V5, 2VN, 3V1 to 3V5, 3VN, 2W1 to 2W5, 2WN, 3W1 to 3W5, 3WN),
wherein at least two first taps (2U1 to 2U5, 3U1 to 3U5, 2V1 to 2V5, 2VN, 3V1 to 3V5, 2W1 to 2W5, 3W1 to 3W5) of the at least one secondary winding (2U, 3U, 2V, 3V, 2W, 3W) of each first transformer (T1) in each first current supply device (1) are connected with one another via a power controller (11) at a first node (12),
wherein the first node (12) of each first current supply device (1) together with a tap (2UN, 3UN, 2VN, 3VN, 2WN, 3WN) for a reference potential of the at least one secondary winding (2U, 3U, 2V, 3V, 2W, 3W) of the first transformer (T1), to which the first current supply device (1) is connected, forms a first output, to which a series connection of loads (L1 to L6) is connected,
wherein the at least one second current supply device (2) has at least one input (20) with n terminals (201, 202, 203) and q converter groups (21) for converting n-phase AC current into m-phase AC current and the input is connected with the q converter groups (21),
wherein the at least one second current supply device (2) has an output (23) with q*m+1 terminals (231, 232, 233, 234, 235, 236, 237) which are connected inside the at least one second current supply device (2) with terminals of the q converter groups (21), wherein the circuit arrangement comprises p first switching groups (3), which each have an output (31) with up to q*m+1 terminals (311, 312, 313, 314, 315, 316, 317), to which the loads (L1 to L6) or a portion of the loads can be connected, which can be connected in series to the first current supply device (1),
which each comprise a group (32) of a controllable switching means (321, 322, 323, 324, 325, 326, 327), wherein the switching means (321, 322, 323, 324, 325, 326, 327) of a first switching group (3) in a closed state connect the terminals (231, 232, 233, 234, 235, 236, 237) of the output (23) of the at least one second current supply device (2) with the terminals (311, 312, 313, 314, 315, 316, 317) of the output (31) of the same first switching group (3),
which have a control input (33) which is connected to the control terminals of the switching means (321, 322, 323, 324, 325, 326, 327),
wherein n, m, p and q are natural numbers,
wherein each terminal (201, 202, 203) of the input (20) of the at least one second current supply device (2) is connected to a first tap (3U4, 3V4, 3W4) of a secondary winding (3U, 3V, 3W) of one of the first transformers (T1), and
wherein the taps (3U4, 3V4, 3W4) for a reference potential of the secondary windings (3U, 3V, 3W) of the first transformers (T1), to which the terminals (201, 202, 203) of the input (20) of the at least one second current supply device (2) are connected, can be connected with one another by way of controllable switching means (41, 42) of a second switching group (4).

2. The current supply arrangement according to claim 1, wherein the first transformers (T1) are connected on the primary side in form of a polygon and can be connected to a multi-phase AC power grid having n phases.

3. The current supply arrangement according to claim 2, wherein the primary windings (1U, 1V, 1W) of the first transformers (T1), to the secondary windings (3U, 3V, 3W) of which the terminals (21, 22, 23) of the input of the at least one second current supply device (2) are connected, are located in different paths of the polygon.

4. The current supply arrangement according to claim 1, wherein the first transformers (T1) comprise more than one secondary winding (2U, 3U, 2V, 3V, 2W, 3W).

5. The current supply arrangement according to claim 3, wherein the secondary windings of the first transformers, to which the terminals of the input of the at least one second current supply device are connected, are different secondary windings than those connected to the first current supply device.

6. The current supply arrangement according to claim 3, wherein the first current supply devices (1) are connected to the secondary windings (3U, 3V, 3W) of the first transformers (T1), to which the terminals (21, 22, 23) of the input of the at least one second current supply device (2) are connected.

7. The current supply arrangement according to claim 6, wherein the first current supply devices (1) are connected to all secondary windings (2U, 3U, 2V, 3V, 2W, 3W) of the first transformers (T1).

8. The current supply arrangement according to claim 1, wherein the at least one converter group (20) comprises at least one or several second transformers (T2).

9. The current supply arrangement according to claim 1, wherein the at least one converter group (20) comprises at least one or several converters (201).

10. The current supply arrangement according to claim 1, wherein the current supply arrangement comprises a controller for controlling the power controllers (11) of the first current supply devices in voltage sequence control,

11. The current supply arrangement according to claim 1, wherein the current supply arrangement comprises a controller for controlling the switching means (321, 322, 323, 324, 325, 326, 327) of the first switching groups (3).

12. The current supply arrangement according to claim 1, wherein the current supply arrangement comprises a controller for controlling the switching means (41, 42) of the second switching group (4).

13. The current supply arrangement according to claim 11, wherein the controller for controlling the switching means (321, 322, 323, 324, 325, 326, 327) of the first switching groups (3) and the switching means (41, 42) of the second switching group (4) are coupled with one another or combined in a controller in such a way that the switching means (41, 42) of the second switching group (4) are dosed only when the switching means (321, 322, 323, 324, 325, 326, 327) of a first switching group (3) are controlled to be closed.

14. The current supply arrangement according to claim 1, wherein the series connection of loads (L1 to L6) are polysilicon rods in a reactor for producing polysilicon according to the Siemens process.
